(19) United States
(12) Patent Application Publication
(10) Pub. No.: US 2020/0394001 A1
(43) Pub. Date: Dec. 17, 2020

(54) PRINTING FUNCTION DISPLAY DEVICE AND INKJET PRINTER

(71) Applicant: MIMAKI ENGINEERING CO., LTD., Nagano (JP)

(72) Inventor: Yuta Kanai, Nagano (JP)

(73) Assignee: MIMAKI ENGINEERING CO., LTD., Nagano (JP)

(21) Appl. No.: 16/902,226

(22) Filed: Jun. 15, 2020

(30) Foreign Application Priority Data
Jun. 17, 2019 (JP) 2019-112250

(51) Int. Cl. G06F 3/12

(52) U.S. Cl. CPC G06F 3/1204; G06F 3/1257; G06F 3/1255

(57) ABSTRACT

A printing function display device is a device that develops a general-purpose user interface for a printing machine that can correspond to each model of a printing machine of a plurality of models. The printing function display device includes a control unit, and the control unit acquires, from a storage unit in which data on a printing function of the printing machine of a plurality of models is stored so as to be reflected on the user interface, data of the printing function of the printing machine of a predetermined model and reflects the data on the user interface to be developed.

### CROSS REFERENCE TO RELATED APPLICATIONS

This application claims the priority benefit of Japanese Patent Application No. 2019-112250, filed on Jun. 17, 2019. The entirety of the above-mentioned patent application is hereby incorporated by reference herein and made a part of this specification.

### TECHNICAL FIELD

The present disclosure relates to a printing function display device and an inkjet printer.

### DESCRIPTION OF THE BACKGROUND ART

There is known an apparatus which is connected to a printing machine to display status information of the printing machine and transmit a printing image to the printing machine (e.g., Japanese Unexamined Patent Publication No. 2006-133892, i.e., Patent Literature 1).

Patent Literature 1: Japanese Unexamined Patent Publication No. 2006-133892

### SUMMARY

In the apparatus described in Japanese Unexamined Patent Publication No. 2006-133892, an electronic manual related to the printing machine can be displayed. With this configuration, if the user wants to know the printing functions that can be used on the printing machine of the model owned by the user, the user needs to find out from a large amount of electronic manuals. Thus, there is a problem that it becomes difficult for the user to recognize the available printing functions. Furthermore, there is a problem that it is troublesome to check whether a printing function that a user wants to use corresponds to a printing machine of a model owned by the user.

The present disclosure has been contrived in view of the above, and the present disclosure provides a printing function display device and an inkjet printer that enables a printing function usable in a printing machine to be easily recognized depending on a model.

In order to solve the problems described above and to realize the present disclosure, a printing function display device of the present disclosure relates to a printing function display device that develops a user interface having general-purpose for a printing machine capable of corresponding to each model of a printing machine of a plurality of models, where the printing machine display device includes a control unit that is configured to: acquire, from a storage unit storing in which data related to a printing function of the printing machine of a plurality of models is stored so as to be reflected on the user interface, a data of the printing function of the printing machine of a model that is predetermined; and reflect the data on the user interface. According to this configuration, the printing function display device of the present disclosure can provide a general-purpose user interface that does not depend on the model of printing machine, in a form appropriately corresponding to each model of the printing machine. Furthermore, the printing function display device according to the present disclosure can acquire and display information on the printing function of the printing machine of the model for each model whose registration has been accepted using the user interface, and thus can easily recognize the printing function that can be used by the printing machine depending on the model without having to search for them from a large amount of manual.

In this configuration, preferably, an information on the printing function of the printing machine of the model is displayable on the user interface, and a selecting unit that selects the printing function to be displayed on the user interface from a plurality of the printing functions is further provided. According to this configuration, the printing function display device of the present disclosure can appropriately display and provide the printing function desired by the user through the selecting unit displayed on the user interface.

In the configuration having the selecting unit, more preferably, the selecting unit is displayed on the user interface and a plurality of the selecting unit is provided according to the printing function, and a display mode in the user interface is changed according to a usage frequency. According to this configuration, the printing function display device of the present disclosure appropriately predicts, displays, and provides the printing function desired by the user by using the user interface according to the usage mode of the printing machine of the user.

Furthermore, in these configurations, preferably, the control unit is configured to optimize the user interface based on a relationship of at least two of characteristics of the printing machine, type of ink used by the printing machine, and type of printing medium used by the printing machine. According to this configuration, the printing function display device of the present disclosure can appropriately optimize, display, and provide the printing function using the user interface based on the usage mode of the printing machine.

In the above configuration, it is preferable that the control unit is configured to change the user interface based on a condition change performed on the printing machine. According to this configuration, the printing function display device of the present disclosure can appropriately change, display, and provide the printing function using the user interface based on the usage conditions in which the printing machine is placed.

In order to solve the problems described above and to realize the present disclosure, an inkjet printer according to the present disclosure includes the printing function display device described above.

According to the present disclosure, a printing function display device and an inkjet printer can be provided that can easily recognize a printing function usable in a printing machine depending on a model.

### BRIEF DESCRIPTION OF THE DRAWINGS

FIG. 1 is a schematic configuration view schematically showing a usage mode of a printing function display device according to an embodiment.

FIG. 2 is a functional block diagram showing a printing function display device according to the embodiment.

FIG. 3 is a view schematically showing a printing function database according to the embodiment.

FIG. 4 is a view schematically showing an outline of an execution history database according to the embodiment.

FIG. 5 is a view schematically showing an outline of the usage history database according to the embodiment.

FIG. 6 is a view showing an example of a printing display screen according to the embodiment.

FIG. 7 is a view showing an example of a function introduction screen according to the embodiment.

FIG. 8 is a view showing an example of an ink replacement function of a function introduction screen according to the embodiment.

FIG. 9 is a view showing an example of a notification screen according to the embodiment.

### DETAILED DESCRIPTION OF EMBODIMENTS

An embodiment according to the present disclosure will be described in detail below based on the drawings. It should be noted that the present disclosure is not to be limited by the embodiment. Furthermore, the constituent elements in the following embodiment include those that can be easily replaced by those skilled in the art, or those that are substantially the same. Moreover, the constituent elements described below can be appropriately combined, and when there is a plurality of embodiments, it is also possible to combine the respective embodiments.

### Embodiment

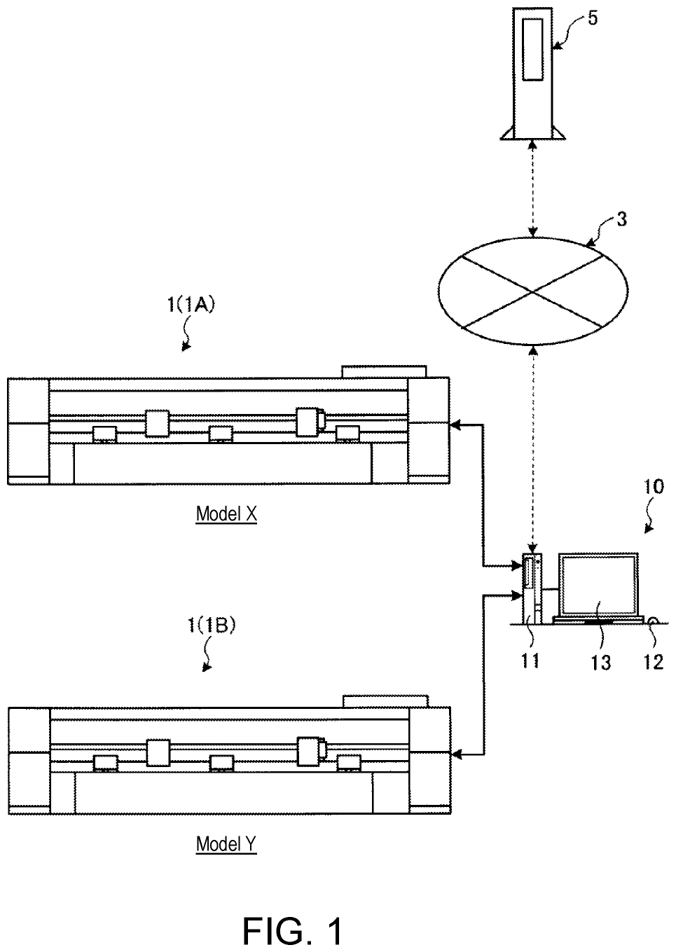

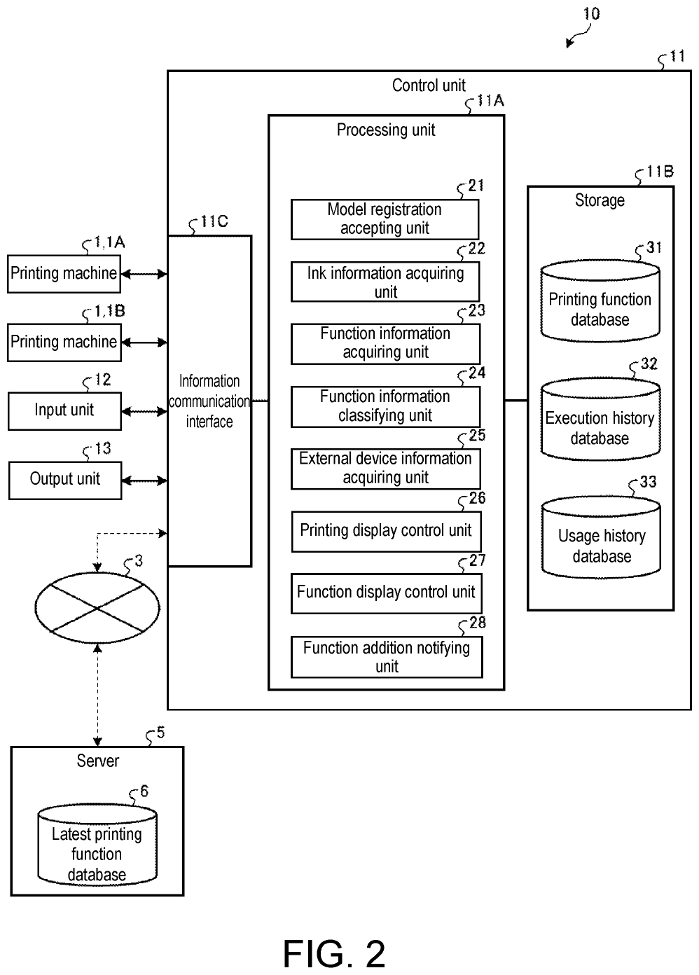

FIG. 1 is a schematic configuration view showing an outline of a usage pattern of a printing function display device 10 according to an embodiment. FIG. 2 is a functional block diagram showing a printing function display device according to the embodiment. As shown in FIGS. 1 and 2, the printing function display device 10 according to the embodiment is electrically connected to a printing machine 1 so as to be able to communicate information, and is a device that develops a user interface for a general-purpose printing machine 1 that does not depend on the model of the printing machine 1 and can correspond to each model of a plurality of predetermined printing machines 1. In the present embodiment, the printing function display device 10 is connected to a printing machine 1A of model X and a printing machine 1B of model Y, but the present disclosure is not limited thereto, and the printing machine 1 of only one type of model may be connected or the printing machine 1 of three or more types of model may be connected. In the present embodiment, the printing machine 1 is, for example, an inkjet printer, but is not limited thereto. As shown in FIGS. 1 and 2, the printing function display device 10 is connected to a server 5 through a communication network 3 so as to be able to communicate information.

As shown in FIGS. 1 and 2, the printing function display device 10 includes a control unit 11, an input unit 12, and an output unit 13. The control unit 11 is electrically connected to the input unit 12 and the output unit 13 so as to be able to communicate information.

The input unit 12 is an interface that receives input of various data from an externally connected device and an interface that receives input from a user, and is exemplified as a mouse and a keyboard in the present embodiment. The input unit 12 is not limited thereto, and may be a touch panel integrated with a display device or the like. The input unit 12 transmits input information or the like to the control unit 11.

The output unit 13 is an interface that displays and outputs various data transmitted from the control unit 11 as characters, images, moving images, and the like, and is exemplified as a liquid crystal display device in the present embodiment. The output unit 13 is not limited thereto, and may be a touch panel integrated with an input device or the like.

As shown in FIG. 2, the control unit 11 includes a processing unit 11A, a storage 11B, and an information communication interface 11C. In the present embodiment, the control unit 11 is exemplified by a computer as a suitable example, but the present disclosure is not limited thereto, and as long as it has a capacity to withstand the calculation process of the processing unit 11A and the storage process of the storage 11B, a mobile phone including a high-performance mobile phone (so-called smart phone), a tablet terminal, a notebook or desktop PC, a PDA that is a mobile information terminal, and a glasses-type or watch-type wearable device or the like may also be used.

The processing unit 11A is a controller, for example, and is realized by various programs (corresponding to one example of printing function display program) stored in the storage 11B, which is a storage device inside the printing function display device 10, being executed by a CPU (Central Processing Unit), an MPU (Micro Processing Unit), and the like with RAM (Random Access Memory) as a work region. The processing unit 11A is, for example, a controller, and is realized by an integrated circuit such as an ASIC (Application Specific Integrated Circuit) or an FPGA (Field Programmable Gate Array). The processing unit 11A is connected to an information communication interface 11C that accepts input of various data from the input unit 12 and outputs various data to the output unit 13.

As shown in FIG. 2, the processing unit 11A is electrically connected to the storage 11B and the information communication interface 11C so as to be able to communicate information with each other, and performs a control function of controlling each of these components. That is, the processing unit 11A, together with the storage 11B, performs a control function and causes the printing function display device 10 according to the embodiment to execute the function including a function as a printer driver that develops a so-called user interface of the printing machine 1.

As shown in FIG. 2, the processing unit 11A includes a model registration accepting unit 21, an ink information acquiring unit 22, a function information acquiring unit 23, a function information classifying unit 24, an external device information acquiring unit 25, a printing display control unit 26, a function display control unit 27, and a function addition notifying unit 28. Each unit included in the processing unit 11A, that is, the model registration accepting unit 21, the ink information acquiring unit 22, the function information acquiring unit 23, the function information classifying unit 24, the external device information acquiring unit 25, the printing display control unit 26, the function display control unit 27 and the function addition notifying unit 28 is a function unit realized by the processing unit 11A executing the printing function display program. Specific functions of the model registration accepting unit 21, the ink information acquiring unit 22, the function information acquiring unit 23, the function information classifying unit 24, the external device information acquiring unit 25, the printing display control unit 26, the function display control unit 27, and the function addition notifying unit 28 will be described later.

The storage 11B is implemented by, for example, a semiconductor memory element such as a ROM (Read Only Memory), a RAM (Random Access Memory), or a flash memory, or a storage device such as a hard disk or an optical disk. As shown in FIG. 2, the storage 11B stores and save a printing function database 31, an execution history database 32, and a usage history database 33.

The storage 11B stores and saves various information generated by the processes of each unit included in the processing unit 11A, that is, the model registration accepting unit 21, the ink information acquiring unit 22, the function information acquiring unit 23, the function information classifying unit 24, the external device information acquiring unit 25, the printing display control unit 26, the function display control unit 27, and the function addition notifying unit 28.

The information communication interface 11C connects the processing unit 11A and the printing machines 1A and 1B, the input unit 12, and the output unit 13 so as to be able to communicate information with each other in a wired or wireless manner. The information communication interface 11C connects the processing unit 11A and the server 5 through the communication network 3 so as to communicate information.

The information communication interface 11C receives status information on the printing machines 1A and 1B from the printing machines 1A and 1B, respectively, and transmits the status information to the processing unit 11A. Here, the status information on the printing machines 1A and 1B includes print conditions set in the printing machines 1A and 1B, information on standby of the printing process in the printing machines 1A and 1B (power saving mode, preparation OK, etc.), and information on the remaining amount of the material consumed by the printing process in the printing machines 1A and 1B (remaining amount of the printing medium such as paper, remaining amount of ink, etc.). The information communication interface 11C receives various data related to printing process generated by the processing unit 11A and a printing image which is print data from the processing unit 11A, and transmits them to the printing machines 1A and 1B, respectively.

The information communication interface 11C receives, from the input unit 12, various data received by the input unit 12, and transmits the data to the processing unit 11A. The information communication interface 11C receives various data generated by the processing unit 11A from the processing unit 11A and transmits the data to the output unit 13.

The information communication interface 11C receives a latest printing function database 6 from the server 5 through the communication network 3, and transmits the latest printing function database 6 to the processing unit 11A. The processing unit 11A further transmits the received latest printing function database 6 to the storage 11B. The storage 11B updates the printing function database 31 based on the received latest printing function database 6.

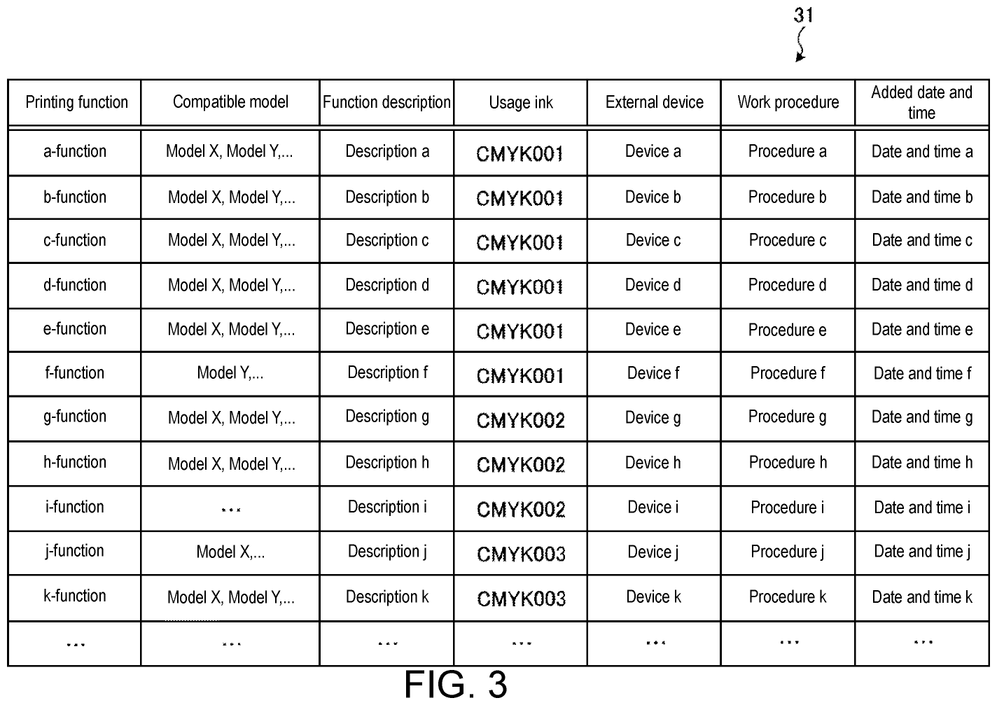

FIG. 3 is a view schematically showing the printing function database 31 according to the embodiment. As shown in FIG. 3, the printing function database 31 is data collection in which a printing function, a list of models of the printing machine 1 corresponding to each printing function, a function description on the printing function, a type of ink used when executing the printing function, a list of external devices required when executing the printing function, a work procedure when executing the printing function, and an added date and time at which the printing function is added to the printing function database 31 are registered at one-to-one correspondence. Here, in the printing function database 31 shown in FIG. 3, each column of the function description, the usage ink, the external device, the work procedure, and the added date and time is simplified and described with one item, but is different for each model. Some of these items may be common among some models.

In the present embodiment, the printing function is a function required due to a characteristic of a printing medium such as printing on a surface of a woven fabric or a golf ball, a function due to a characteristic of a form formed by a print method and a printing process such as multilayer overlay printing or Braille printing, and the like.

In the present embodiment, the type of ink refers to the type of ink set, for example, CMYK series is a type of ink in which cyan (Cyan), magenta (Magenta), yellow (Yellow) and key plate (Key plate) form a set.

The latest printing function database 6, which is stored in the server 5 and updated as needed, is the latest version of the printing function database 31, and its mode is the same as that of the printing function database 31, and thus the detailed description thereof will be omitted.

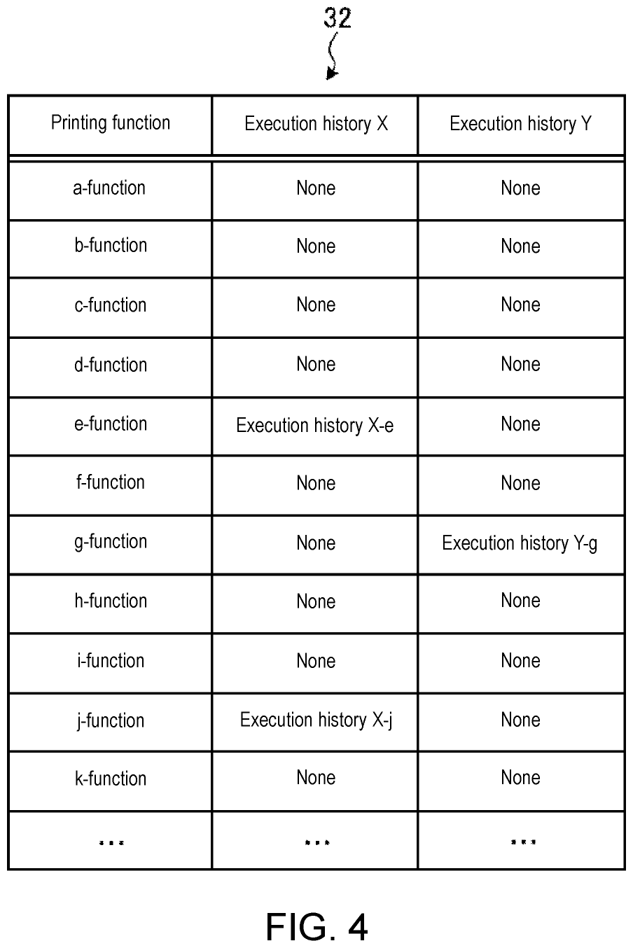

FIG. 4 is a view schematically showing an outline of the execution history database 32 according to the embodiment. As shown in FIG. 4, the execution history database 32 is a data collection in which each printing function registered in the printing function database 31 and the execution history of each printing function are stored at one-to-one correspondence for each model of the printing machine 1. In the execution history database 32 shown in FIG. 4, the execution history regarding the printing machine 1A of model X is stored as execution history X, and the execution history regarding the printing machine 1B of model Y is stored as execution history Y. Here, the execution history of the printing function includes information on whether or not the printing function has been executed, and information on the execution date and time and the executed number of times when there is an execution history.

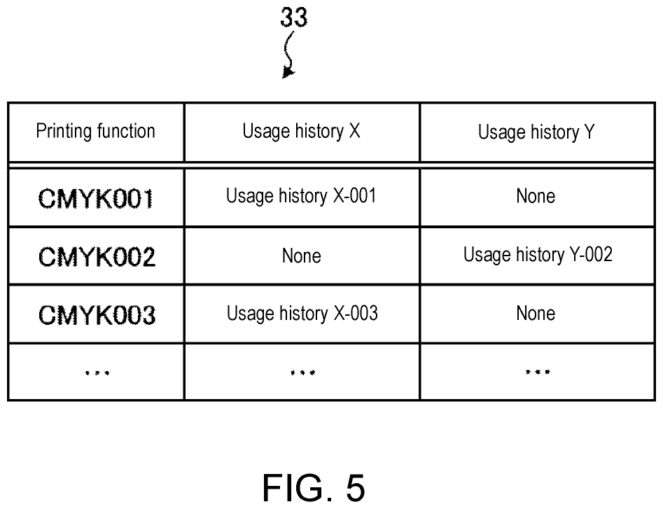

FIG. 5 is a view schematically showing an outline of the usage history database 33 according to the embodiment. As shown in FIG. 5, the usage history database 33 is a data collection in which the type of each ink registered in the printing function database 31 and the usage history of each ink are stored at one-to-one correspondence for each model of the printing machine 1. In the usage history database 33 shown in FIG. 5, the usage history regarding the printing machine 1A of model X is stored as usage history X, and the usage history regarding the printing machine 1B of model Y is stored as usage history Y. Here, the usage history of the printing function includes information on whether or not the ink has been used, and information on the used date and time and the used number of times when there is a usage history.

The model registration accepting unit 21 accepts registration of the model of the printing machine 1. For example, the model registration accepting unit 21 accepts registration of the model X of the printing machine 1A and accepts registration of the model Y of the printing machine 1B. Specifically, when the printing function display device 10 is in an operating state such as when a printing function display program is started, and the printing machine 1 is electrically connected to the information communication interface 11C to be able to communicate information, the model registration accepting unit 21 automatically acquires the information of the model from the printing machine 1 through the information communication interface 11C, and registers the same as the model being used. Furthermore, the model registration accepting unit 21 may accept input of model registration from the output unit 13 through the information communication interface 11C.

The ink information acquiring unit 22 acquires, for each model whose registration has been accepted by the model registration accepting unit 21, information on the type of ink set in the printing machine 1 of the relevant model. For example, the ink information acquiring unit 22 acquires information indicating that the type of ink set in the printing machine 1A of model X is CMYK001, and information indicating that the type of ink set in the printing machine 1B of model Y is CMYK002. The ink information acquiring unit 22 automatically acquires, specifically, similarly to the model registration accepting unit 21, information on the type of set ink from the printing machine 1 through the information communication interface 11C when the printing function display device 10 is in an operating state and the printing machine 1 is electrically connected to the information communication interface 11C to be able to communicate information.

Note that the ink set in the printing machine 1 refers to the ink that is in a used state when the printing process is executed by the printing machine 1. When the ink is not set in the printing machine 1, the ink information acquiring unit 22 acquires information indicating that the ink is not set, instead of the information on the type of ink.

The function information acquiring unit 23 acquires, from the storage unit in which the data on the printing function of the printing machine 1 of a plurality of models is stored so as to be reflected on the user interface, the data of the printing function of the printing machine 1 of a predetermined model and reflects the data on the user interface developed by the printing function display device 10. Here, the storage unit is the server 5 that stores the latest printing function database 6, or the storage 11B that stores the printing function database 31. That is, for example, when the control unit 11 of the printing function display device 10 is online, the function information acquiring unit 23 may acquire the new printing function database 6 from the server 5 through the communication network 3 and the information communication interface 11C and reflect the same on the user interface developed by the printing function display device 10 based on the new printing function database 6, or for example, when the control unit 11 of the printing function display device 10 is offline, the function information acquiring unit may acquire the printing function database 31 from the storage 11B and reflect the same on the user interface developed by the printing function display device 10 based on the printing function database 31. Furthermore, in the present embodiment, when referring to being stored so as to be able to be reflected on the user interface, this means, being stored in a form that can be suitably simplified and reflected even on a user interface optimized in a form corresponding to any model, that is, a state in which the data format is suitably made common for the respective models of the printing machine 1.

In addition, the function information acquiring unit 23 can acquire, for each model whose registration has been accepted by the model registration accepting unit 21, information on a printing function of the printing machine 1 of the relevant model. Here, the printing function of the printing machine 1 refers to a printing function that the printing machine 1 can handle by preparing predetermined inks, predetermined external devices, and the like and executing a printing process in accordance with a predetermined work procedure. Specifically, the function information acquiring unit 23 refers to the printing function database 31 stored in the storage 11B to extract the printing function in which the model of the printing machine 1 is included in the compatible model.

For example, the function information acquiring unit 23 extracts and acquires, as printing functions of the printing machine 1A of model X, a-function, b-function, c-function, d-function, e-function, f-function, g-function, h-function, j-function, and k-function which are printing functions including the model X in the column of the compatible model in the table of the printing function database 31 shown in FIG. 3. Furthermore, for example, the function information acquiring unit 23 extracts and acquires, as printing functions of the printing machine 1B of model Y, a-function, b-function, c-function, d-function, e-function, f-function, g-function, h-function, and k-function which are printing functions including the model Y in the column of the compatible model in the table of the printing function database 31 shown in FIG. 3.

The function information classifying unit 24 classifies the printing functions acquired for each model of the printing machine 1 for each type of ink to be used. Specifically, the function information classifying unit 24 classifies the printing function extracted and acquired by the function information acquiring unit 23 by the type of usage ink, with reference to the printing function database 31 stored in the storage 11B.

For example, the function information classifying unit 24 classifies the printing functions of the printing machine 1A of model X to a-function, b-function, c-function, d-function, and e-function in which the column of the usage ink is CMYK001 in the printing function database 31 stored in the storage 11B, g-function and h-function in which the column of the usage ink is CMYK002, and j-function and k-function in which the column of usage ink is CMYK003. For example, the function information classifying unit 24 classifies the printing functions of the printing machine 1B of model Y to a-function, b-function, c-function, d-function, e-function, and f-function in which the column of the usage ink is CMYK001 in the printing function database 31 stored in the storage 11B, g-function and h-function in which the column of the usage ink is CMYK002, and k-function in which the column of usage ink is CMYK003.

In the present embodiment, the function information classifying unit 24 has been described in detail on a mode in which the printing functions are classified according to the type of usage ink, but in addition, the printing functions are classified by the characteristics related to other printing machines 1 such as the type of printing medium (media) used by the printing machine 1 determined according to the model of the printing machine 1 and the type of usage ink (also include characteristics related to the external device acquired by the external device information acquiring unit 25 described later).

The external device information acquiring unit 25 acquires, for each model and printing function, information on the external device required when the printing machine 1 executes the printing function. The external device includes, for example, a pre-processing machine that adds a printing function of applying a pre-processing agent to a printing medium (media) or a color developing machine that adds a printing function of performing a color developing process for enhancing the color developing function of a printing image to be imaged. Specifically, the external device information acquiring unit 25 references, for each model, the printing function database 31 stored in the storage 11B for each printing function acquired by the function information acquiring unit 23 to acquire the information on the external device necessary for execution.

For example, the external device information acquiring unit 25 acquires, for the printing machine 1A of model X, information on each external device such as the external device required to execute the a-function is the device a, the external device required to execute the b-function is the device b, and the like. The same applies to the printing machine 1B of model Y.

In the present embodiment, the printing function display device 10 acquires printing functions separately for each model of the printing machine 1 by the function information acquiring unit 23 of the control unit 11, and based on the classification of the printing functions of the printing machine 1 for every type of usage ink, type of printing medium used by the printing machine 1, and the characteristics related to other printing machines 1 by the function information classifying unit 24 of the control unit 11, the control unit 11 optimizes the user interface to be developed and uses such user interface to suitably use or selectively present the printing function such as to enable a specifically determined printing process of the printing machine 1 to be executed in a form suitable for each model of the printing machine 1. The control unit 11 of the printing function display device 10 optimizes the user interface based on, for example, a relationship of at least two of the characteristics related to the printing machine 1, the type of ink used by the printing machine 1, and the type of printing medium used by the printing machine 1, and uses the user interface to suitably use or selectively present the printing function of the printing machine 1 such as to enable the specifically determined printing process of the printing machine 1 to be executed in a form suitable for each model of the printing machine 1.

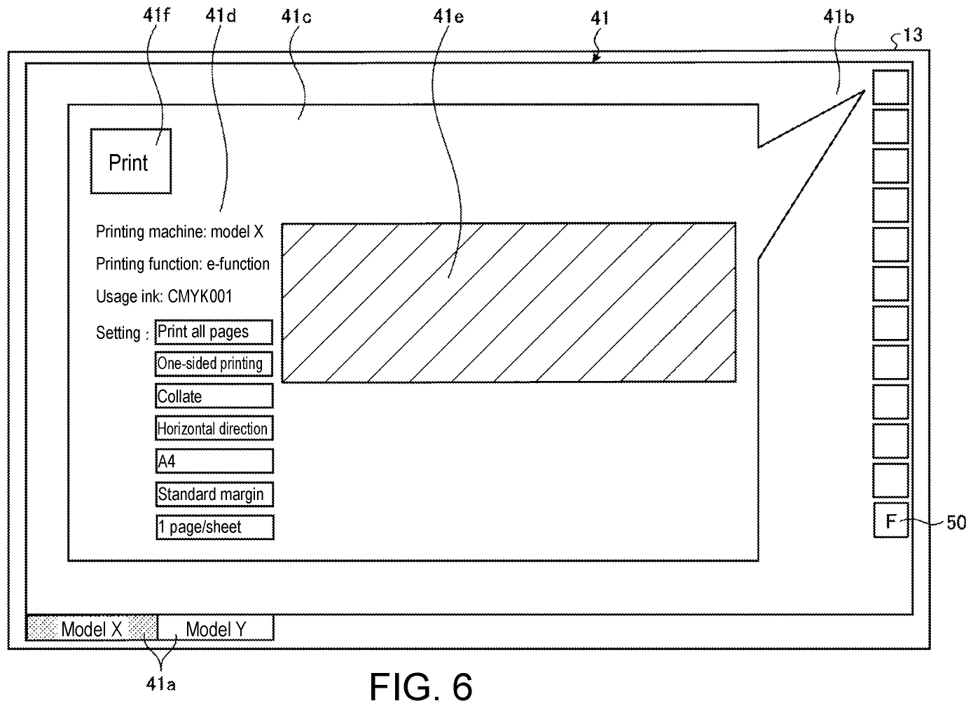

FIG. 6 is a view showing an example of a printing display screen 41 according to the embodiment. The printing display screen 41 shown in FIG. 6 is an example of one screen in the user interface developed by the printing function display device 10. When a command to perform printing using the printing machine 1 is input, the printing display control unit 26 causes the output unit 13, which is a display unit, to display the printing display screen 41 as shown in FIG. 6 including a print button 41f that causes the printing machine 1 to start printing and function information introduction button 50 that displays the information on the printing function for the model of the printing machine 1.

For example, as shown in FIG. 6, as the printing display screen 41, the printing display control unit 26 causes the output unit 13 to display a screen that displays status information on the printing machine 1 or the printing image. Specifically, the printing display control unit 26 first creates the printing display screen 41 based on the status information on the printing machine 1 or the printing image acquired by the processing unit 11A, and the various arrangement information necessary for creating various display images stored in advance in the storage 11B. The printing display control unit 26 transmits the created printing display screen 41 together with an image display command to the output unit 13 through the information communication interface 11C to cause the output unit 13 to display the printing display screen 41.

As shown in FIG. 6, the printing display screen 41 has a model selection tab 41a, a frame portion 41b, and a main information display portion 41c. The model selection tab 41a is provided generally commonly in any of the outer peripheral regions for substantially all the screens including the printing display screen 41, and in the present embodiment, is a display part provided in a region at the lower left end. The model selection tab 41a can switch the screens to display according to the model by being selected through the input unit 12.

A frame portion 41b is provided generally commonly in any of the outer peripheral regions for substantially all the screens including the printing display screen 41, and in the present embodiment, is a display part provided in a region at the right side end. The frame portion 41b is a display part in which screen selection buttons, which can switch between screens that can be displayed by the printing function display device 10 according to the embodiment and function according to selection, are arranged. The model selection tab 41a and the frame portion 41b are provided in different regions from each other in the outer peripheral region of the screen.

Here, among the screen selection buttons arranged in the frame portion 41b, the function introduction button 50 arranged at the bottom is a button that accepts the input of switching the display according to the selection and displaying a-function introduction screen 42 described later. That is, the printing display screen 41 is provided with the function introduction button 50 for accepting an input to display the function introduction screen 42 in the frame portion 41b.

A main information display portion 41c is provided over the central region of the printing display screen 41, and is a display part that displays status information on the printing machine 1 or a printing image, which is main information for the printing display screen 41. In the present embodiment, the main information display portion 41c includes a status information display region 41d for displaying status information related to the printing machine 1, a printing screen display region 41e for displaying a printing image that can be transmitted to the printing machine 1, and a print button 41f that accepts an input to transmit the printing screen to the printing machine 1 and issue a print command by being selected.

The printing display screen 41 is not limited to the mode shown in FIG. 6, and may be a screen that displays the status information on other printing machines 1 or the printing image such as a screen for displaying the remaining amount of usage ink, which is status information related to the printing machine 1, or the like.

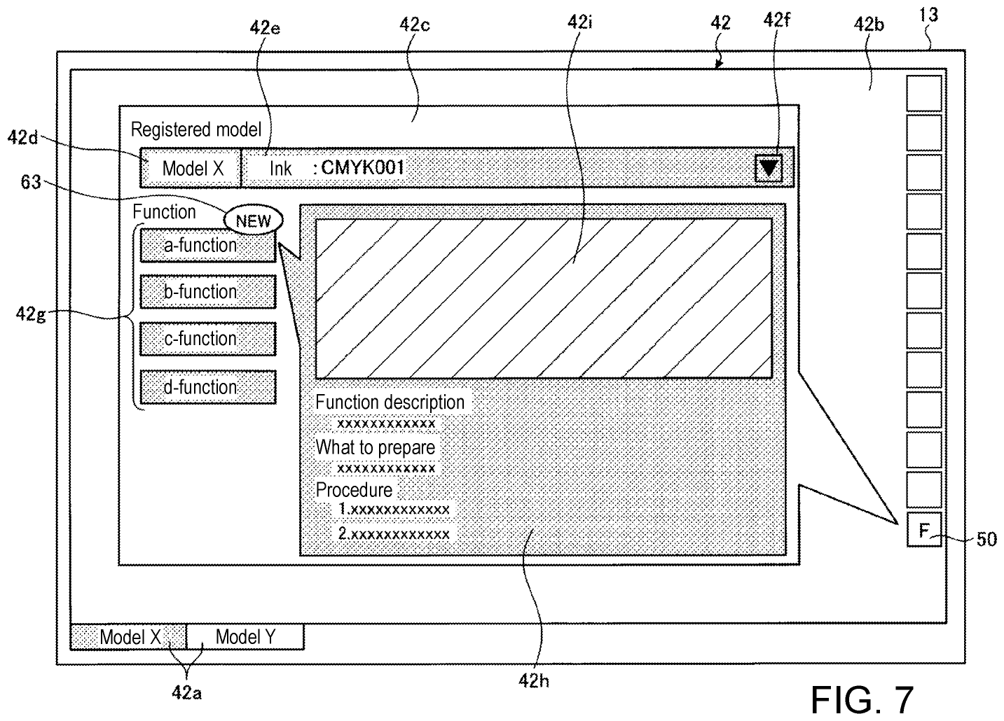

FIG. 7 is a view showing an example of the function introduction screen 42 according to the embodiment. The function introduction screen 42 shown in FIG. 7 is an example of one screen in the user interface developed by the printing function display device 10. That is, the printing function display device 10 causes the output unit 13 to display the function introduction screen 42 shown in FIG. 7 by the function display control unit 27 described later to be able to display information related to the printing function of the printing machine 1 of the predetermined model. When the input is made by the function introduction button 50 displayed on the display screen such as the printing display screen 41, for example, the function display control unit 27 causes the output unit 13 to display the function introduction screen 42 as shown in FIG. 7 including information of the printing function of the printing machine 1 of the relevant model for each model of the printing machine 1.

Specifically, the function display control unit 27 first acquires information on the printing function of the printing machine 1 acquired for each model of the printing machine 1 by the function information acquiring unit 23 and classified for each type of usage ink by the function information classifying unit 24, and based on such information, creates a plurality of function introduction screens 42 that displays the printing functions executable by the printing machine 1 for each model of the printing machine 1 and for each type of usage ink. The function display control unit 27 develops the user interface by creating a plurality of function introduction screens 42 based on the relationship between the model of the printing machine 1 and the type of ink used by the printing machine 1 as described above. Note that the function display control unit 27 is not limited to only these two relationships, and can also develop the user interface based on other two relationships such as characteristics relating to other printing machines 1.

The function display control unit 27 specifies one of the models of the printing machine 1 accepted by the model registration accepting unit 21 and, from the plurality of created function introduction screens 42, selects a-function introduction screen 42 on the specified model and the type of set ink acquired by the ink information acquiring unit 22 for the printing machine 1 of the relevant model, and transmits the function introduction screen 42 to the output unit 13 through the information communication interface 11C together with an image display command to display the selected function introduction screen 42 to cause the output unit 13 to display the selected function introduction screen 42. The function display control unit 27 of the control unit 11 appropriately changes the user interface to be developed according to change in the model of the printing machine 1, and the like such as changing the model related to the function introduction screen 42 to be initially displayed based on the change in the connected printing machine 1.

As shown in FIG. 7, the function introduction screen 42 includes a model selection tab 42a, a frame portion 42b, and a main information display portion 42c. The model selection tab 42a is substantially the same as the model selection tab 41a described above, but further has a function as a selecting unit for selecting a printing function to be displayed on the user interface from a plurality of printing functions. The frame portion 42b is substantially the same as the frame portion 41b described above, but further has a function as a selecting unit for selecting a printing function to be displayed on the user interface from a plurality of printing functions.

The main information display portion 42c is provided over the central region of the function introduction screen 42, and is a display portion that displays the printing function of the printing machine 1 that is the main information for the function introduction screen 42. In the present embodiment, the main information display portion 42c includes a model display region 42d, a usage ink display region 42e, a usage ink display development button 42f, a printing function array region 42g, a printing function detailed display region 42h, and a new image display region 42i.

The model display region 42d is a display region for displaying the model of the printing machine 1. In the model display region 42d, when the function introduction screen 42 is displayed for the first time, a model specified from the models of the printing machine 1 accepted by the model registration accepting unit 21 is displayed by the function display control unit 27. In the model display region 42d, the display is switched to the selected model according to the selection of the model selection tab 42a.

The usage ink display region 42e is a display region where one type of usage ink of the printing machine 1 is selected and displayed. In the usage ink display region 42e, when the function introduction screen 42 is displayed for the first time, a type of ink being set acquired by the ink information acquiring unit 22 for the printing machine 1 of the model displayed in the model display region 42d is displayed by the function display control unit 27. When the type of ink being set in the printing machine 1 is changed, the function display control unit 27 of the control unit 11 can add changes to the user interface to be developed such as changes the type of ink to initially display in the usage ink display region 42e based on the change in the type of usage ink, and use such an user interface to suitably use or selectively present the printing function of the printing machine 1 in a form of suitably corresponding to the changed print condition. Not limited to the change in the connection state of the printing machine 1 or the change in the type of usage ink described above, the function display control unit 27 of the control unit 11 can add changes to the user interface to be developed based on the change in condition performed on the printing machine 1, and use such an user interface to suitably use or selectively present the printing function of the printing machine 1 in a form of suitably corresponding to the changed print condition. For example, the function display control unit 27 of the control unit 11 may add changes to the user interface to be developed based on a change in condition of setting performed on the printing machine 1, change due to new connection of an external device, and the like, and use such an user interface to add changes to apply a pre-processing agent or add changes to newly perform a process by a color developing machine.

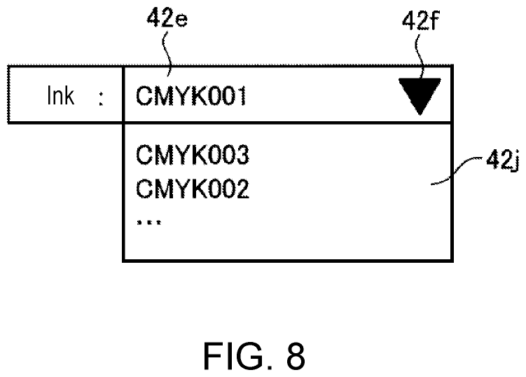

FIG. 8 is a view showing an example of an ink replacement function on the function introduction screen 42 according to the embodiment. The usage ink display development button 42f on the function introduction screen 42 is a button that, when selected, allows the usage ink displayed in the usage ink display region 42e to be changed and replaced with another usage ink. The usage ink display development button 42f is a button for changing the printing function to be displayed in the screen of the user interface to be developed, for example, in the present embodiment, the printing function detailed display region 42h and the new image display region 42i in the function introduction screen 42 to that related to the selected usage ink, and also has a function as a selecting unit for accepting the selection of the printing function.

The function display control unit 27 causes the output unit 13 to display the usage ink development display 42j as shown in FIG. 8 when the usage ink display development button 42f is selected. The usage ink development display 42j displays an array of usage inks that can be used by the printing machine 1 of the model displayed in the other model display region 42d other than the usage ink being displayed in the usage ink display region 42e.

When each display of the usage ink arrayed in the usage ink development display 42j is selected, the display of the usage ink display region 42e is switched to the selected usage ink by the function display control unit 27.

The function display control unit 27 refers to the usage history database 33 stored in the storage 11B, and can display an array of usage inks in order from high priority based on the usage history of the printing machine 1 of the relevant model in the usage ink development display 42j. Here, the priority based on the usage history is a parameter that is higher the more recent the usage time, and higher the greater the number of usage times. This facilitates the selection of the usage ink that is likely to be used again in the usage ink development display 42j.

The printing function array region 42g is a display region that displays in an array form the buttons of the printing functions of the printing machine 1 of the model displayed in the model display region 42d that can be executed with the usage ink displayed in the usage ink display region 42e. The buttons of the printing functions arrayed and displayed in the printing function array region 42g also have a function as a selecting unit for accepting selecting of the printing function from the plurality of the printing function to display the information in the screen of the user interface to be developed, for example, in the present embodiment, in the printing function detailed display region 42h and the new image display region 42i, to be described later, in the screen.

In the present embodiment, the function display control unit 27 can array and display the buttons of the printing functions in the printing function array region 42g in the screen of the user interface to be developed, and can display a plurality of buttons for four types of printing functions, a-function, b-function, c-function, and d-function in the example of FIG. 7 according to the printing function. Furthermore, the function display control unit 27 can change the display mode in the user interface to be developed according to the usage frequency of the printing function.

In the present embodiment, the function display control unit 27 refers to, for example, the execution history database 32 stored in the storage 11B, and extracts, among the printing functions executable by the printing machine 1 of the relevant model with the relevant usage ink, only the printing function without history of execution, and array and display such printing function in the printing function array region 42g. For example, in the present embodiment, the function display control unit 27 excludes the e-function that the model X has executed using the ink CMYK001 in the printing function array region 42g, and displays only the a-function, b-function, c-function and d-function that can be executed by the model X using the ink CMYK001 and that has no history of execution. Thus, only the printing function that has no history of execution and that is new to the owner of the printing machine 1 can be selectively visually recognized. Note that the present disclosure is not limited to this mode, and the function display control unit 27 may array and display the printing function having history of execution in the printing function array region 42g together with the display indicating that there is history of execution. Conversely, the function display control unit 27 may array and display only the printing function having history of execution in the printing function array region 42g in order of high usage frequency.

In accordance with the selection change of the model based on the selection of the model selection tab 42a having a function as a selecting unit, the function display control unit 27 changes the model displayed in the model display region 42d and changes the printing function arrayed and displayed in the printing function array region 42g to the printing function of the selection changed model. In accordance with the selection change of the usage ink based on the selection of the usage ink display development button 42f and the usage ink development display 42j having a function as a selecting unit, the function display control unit 27 changes the usage ink displayed in the usage ink display region 42e and changes the printing function arrayed and displayed in the printing function array region 42g to the printing function executed with the selection changed usage ink. Thus, the function display control unit 27 changes the printing functions displayed in an array form according to the selection change of the model and the selection change of the usage ink through a button having a function as a selecting unit, and the like.

The printing function detailed display region 42h is a display region that displays at least one of function description information, external device information, and work procedure information for the printing function selected from the printing functions arrayed in the printing function array region 42g.

The function display control unit 27 refers to the printing function database 31 stored in the storage 11B, and can extract at least one of the function description information, the external device information, and the work procedure information associated with the selected printing function among the printing functions arrayed in the printing function array region 42g and display the information in the printing function detailed display region 42h. Thus, for a new printing function that has not been executed, it is possible to promote understanding of the details of the printing function, to appropriately provide information on external devices necessary for executing the printing function in an easily understandable manner, and to provide a work procedure for executing the printing function in an easily understandable manner.

In accordance with the selection change of the printing function selected through the printing function button having the function as the selecting unit, the function display control unit 27 changes the information to be displayed in the printing function detailed display region 42h to at least one of the function description information, the external device information, and the work procedure information corresponding to the selection changed printing function.

The new image display region 42i is a display region that displays a sample image created by the function display control unit 27, assuming that the printing process has been executed by the selected printing function of the printing functions arrayed in the printing function array region 42g.

In accordance with the selection change of the printing function selected through the printing function button having the function as the selecting unit, the function display control unit 27 changes the sample image to be displayed in the new image display region 42i to a sample image created according to the selection changed printing function.

As described above, the function display control unit 27 displays the function introduction screen 42 in which the printing function of one of the models of the printing machine 1 accepted by the model registration accepting unit 21 is displayed. Furthermore, the function display control unit 27 displays the function introduction screen 42 in which the printing functions of the printing machine 1 are classified and displayed for each type of ink to be used. Furthermore, the function display control unit 27 displays the function introduction screen 42 in which the printing functions classified to the same type of ink as the ink being set are displayed. Furthermore, the function display control unit 27 displays the function introduction screen 42 in which the printing function and information on an external device necessary for executing the printing function are displayed in comparison.

In the printing function display device 10 according to the embodiment, when the latest printing function database 6 stored in the server 5 is updated, the processing unit 11A receives a notification that the latest printing function database 6 has been updated through the information communication interface 11C, and in response thereto, a version upgrade operation is executed to update the printing function database 31 based on the updated latest printing function database 6.

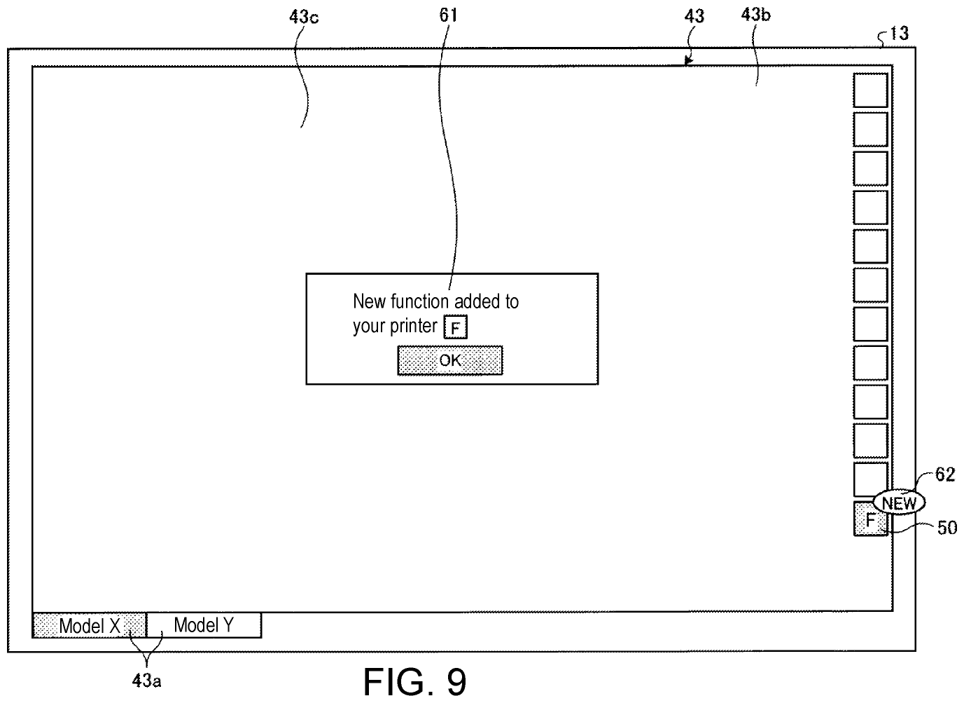

FIG. 9 is a view showing an example of a notification screen 43 according to the embodiment. When the printing function of the printing machine 1 of the model whose registration is accepted by the model registration accepting unit 21 is added by the update of the printing function database 31 involved in the version upgrade operation of the printing function display device 10, the function addition notifying unit 28 displays a notification screen 43 as shown in FIG. 9 to notify the addition of the printing function of the printing machine 1 of the relevant model in accordance with the startup of the printing function display device 10.

As shown in FIG. 9, the notification screen 43 includes a model selection tab 43a, a frame portion 43b, and a main information display portion 43c. The model selection tab 43a is the same as the model selection tab 41a and the model selection tab 42a described above, and thus a detailed description thereof will be omitted. In addition, the frame portion 43b is the same as the frame portion 41b and the frame portion 42b described above, and thus a detailed description thereof will be omitted.

The main information display portion 43c is a display part provided over the central region of the notification screen 43 to display additional notification of the printing function of the printing machine 1 which is the main information for the notification screen 43. In the present embodiment, the main information display portion 43c displays, in a pop-up, a notification display 61 for notifying the addition of the printing function of the printing machine 1.

As shown in FIG. 9, the function addition notifying unit 28 gives the function introduction button 50 a new addition display 62 that is information indicating that a printing function of the printing machine 1 has been newly added. Furthermore, as shown in FIG. 7, when the a-function is a newly added printing function, the function addition notifying unit 28 adds the new addition display 63 that is information indicating that the printing function has been newly added to the display of the added printing function (a-function).

The function addition notifying unit 28 refers to the printing function database 31 stored in the storage 11B, and can continuously add new addition displays 62 and 63 until the added date and time of the newly added printing function is a predetermined time or older. Here, the predetermined time is, for example, one week or one month. In this way, the newly added printing function can be more reliably recognized.

The printing function display device 10 according to the embodiment can provide a general-purpose user interface that does not depend on the model of the printing machine 1 in a form appropriately corresponding to each model of the printing machine 1 according to the configuration described above. Furthermore, the printing function display device 10 according to the embodiment can acquire and display information on the printing function of the printing machine 1 of the model for each model whose registration has been accepted, and thus can easily recognize the printing function that can be used by the printing machine 1 depending on the model without having to search for them from a large amount of manual.

Moreover, the printing function display device 10 according to the embodiment can easily display information of the printing functions by selecting a function introduction button 50 provided on the printing display screen 41 related to the printing process using the printing machine 1, and thus it becomes possible to easily know the printing function for every model of the printing machine 1 owned by the user when using the printing machine 1 at a timing when the user is likely to be concerned about the printing function for each model of the printing machine 1 when the printing machine 1 is in use.

Furthermore, the printing function display device 10 according to the embodiment is provided with the display function of the information of the printing function of the printing machine 1 for each model in a form of accompanying the application used in transmitting the printing image for the printing process using the printing machine 1, and the like, and thus the application providing side can easily provide the information of the printing function to the user of the printing machine 1 while substantially suppressing increase in capacity load that may be applied to the device on the user side of the printing machine 1.

In addition, the printing function display device 10 according to the embodiment develops a general-purpose user interface for the printing machine 1 that does not depend on the model of the printing machine 1, and can acquire the new printing function database 6 through the communication network 3 and the information communication interface 11C from the server 5 and reflect the same on the user interface developed by the printing function display device 10 based on the new printing function database 6, or can acquire the printing function database 31 from the storage 11B and reflect the same on the user interface developed by the printing function display device 10 based on the printing function database 31. For this reason, the printing function display device 10 according to the embodiment can be used by a user owns a printing machine 1 of any type and selectively easily provide the user information regarding the printing function of the printing machine 1 of the model owned by the user.

Furthermore, the printing function display device 10 according to the embodiment can display information on the printing function of the printing machine 1 of the model on a user interface to be developed, and further includes a selecting unit (model selection tab 42a, usage ink display development button 42f, and printing function button) for selecting the printing function to be displayed on the user interface from a plurality of printing functions. Therefore, the printing function display device 10 according to the embodiment can appropriately display and provide the printing function desired by the user through the selecting unit displayed on the user interface.

Furthermore, in the printing function display device 10 according to the embodiment, the selecting units are displayed on the user interface and a plurality of the selecting units are provided according to the printing function, so that a display mode in the user interface is changed according to the usage frequency. Thus, the printing function display device 10 according to the embodiment appropriately predicts, displays, and provides the printing function desired by the user using such user interface according to the usage mode of the printing machine 1 of the user.

Furthermore, in the printing function display device 10 according to the embodiment, the control unit 11 optimizes the user interface based on a relationship of at least two of the characteristics of the printing machine 1, the type of ink used by the printing machine 1, and the type of printing medium used by the printing machine 1. Thus, the printing function display device 10 according to the embodiment can appropriately optimize, display and provide the printing function using the user interface based on the usage mode of the printing machine 1.

Furthermore, in the printing function display device 10 according to the embodiment, the control unit 11 changes the user interface based on the condition change performed on the printing machine 1. Thus, the printing function display device 10 according to the embodiment uses the user interface to appropriately change, display and provide the printing function based on the usage conditions in which the printing machine 1 is placed.

Moreover, the printing function display device 10 according to the embodiment further includes a function information classifying unit 24 that classifies printing functions of the printing machine 1 for each model for each type of ink to be used, and the function display control unit 27 classifies and displays the printing functions for each type of ink to be used. Thus, the printing function display device 10 according to the embodiment can easily recognize the information of the printing function in the printing machine 1 for each model in a state where the printing function is classified for each type of ink to be used.

The printing function display device 10 according to the embodiment further includes, for each type of printing machine 1, an ink information acquiring unit 22 that acquires information on the ink set in the printing machine 1, and the function display control unit 27 displays the printing function classified into the same ink type as the ink being set. Thus, the printing function display device 10 according to the embodiment can easily recognize the information of the printing function that can be executed with the ink currently being used by the printing machine 1 for each model. The printing function display device 10 according to the embodiment meets the needs when the user of the printing machine 1 desires to know a printing function that can be executed without replacing the ink because it is difficult to replace the ink depending on the printing machine 1.

Furthermore, the printing function display device 10 according to the embodiment further includes an external device information acquiring unit 25 that acquires information on the external device required when the printing machine 1 executes the printing function, and the function display control unit 27 displays the printing function and the external device in comparison. Thus, the printing function display device 10 according to the embodiment can easily and appropriately provide information on external device necessary for executing the printing function for a new printing function that has not been executed.

Moreover, the printing function display device 10 according to the embodiment further includes a function addition notifying unit 28 that notifies the addition of the printing function in the printing machine 1 of the model whose registration has been accepted. Thus, the printing function display device 10 according to the embodiment enables the printing machine 1 of the owned model to immediately recognize the newly executable printing function without overlooking it.

In the printing function display device 10 according to the embodiment, the function addition notifying unit 28 further provides information indicating that the printing function is newly added to the display of the added printing function. Thus, the printing function display device 10 according to the embodiment will more reliably recognize the added printing function.

What is claimed is:

1. A printing function display device that develops a user interface having general-purpose for a printing machine capable of corresponding to each model of a printing machine of a plurality of models, the printing machine display device comprising:
a control unit, being configured to:
acquire, from a storage unit in which data related to a printing function of the printing machine of a plurality of models is stored to be reflected on the user interface, a data of the printing function of the printing machine of a model that is predetermined; and
reflect the data on the user interface.

2. The printing function display device according to claim 1, wherein
an information on the printing function of the printing machine of the model is displayable on the user interface, and
a selecting unit that selects the printing function to be displayed on the user interface from a plurality of the printing functions is further provided.

3. The printing function display device according to claim 2, wherein
the selecting unit is displayed on the user interface, and
a plurality of the selecting units is provided according to the printing function, and
a display mode in the user interface is changed according to a usage frequency.

4. The printing function display device according to claim 1, wherein
the control unit is configured to optimize the user interface based on a relationship of at least two of characteristics of the printing machine, type of ink used by the printing machine, and type of printing medium used by the printing machine.

5. The printing function display device according to claim 2, wherein
the control unit is configured to optimize the user interface based on a relationship of at least two of characteristics of the printing machine, type of ink used by the printing machine, and type of printing medium used by the printing machine.

6. The printing function display device according to claim 3, wherein
the control unit is configured to optimize the user interface based on a relationship of at least two of characteristics of the printing machine, type of ink used by the printing machine, and type of printing medium used by the printing machine.

7. The printing function display device according to claim 4, wherein
the control unit is configured to change the user interface based on a condition change performed on the printing machine.

8. The printing function display device according to claim 5, wherein
the control unit is configured to change the user interface based on a condition change performed on the printing machine.

9. The printing function display device according to claim 6, wherein
the control unit is configured to change the user interface based on a condition change performed on the printing machine.

10. An inkjet printer, comprising:
the printing function display device according to claim 1.
